(19) United States
(12) Patent Application Publication
(10) Pub. No.: US 2011/0300366 A1
(43) Pub. Date: Dec. 8, 2011

(54) THERMOREGULATING, CUT-RESISTANT YARN AND FABRIC

(75) Inventor: Giovanni Joseph Ida Henssen, Born (NL)

(73) Assignee: DSM IP ASSETS B.V., Heerlen (NL)

(21) Appl. No.: 13/129,668

(22) PCT Filed: Nov. 26, 2009
(86) PCT No.: PCT/EP2009/065867

§ 371 Date: Aug. 5, 2011

(30) Foreign Application Priority Data
Nov. 26, 2008 (EP) 08020482.9

(51) Int. Cl. D02G 3/44; D02G 3/22; D04H 1/00; B32B 5/26; D04B 1/16; D02G 3/04; D04H 5/00

(52) U.S. Cl. 428/221; 57/252; 57/255; 57/253; 442/198; 442/268; 442/310; 442/334

(57) ABSTRACT

The present invention relates to a yarn providing a fabric manufactured thereof with good resistance against cutting as well as thermoregulation properties, said yarn comprising cut-resistant fibers and moisture-wicking fibers wherein said cut-resistant fibers and said moisture-wicking fibers are staple fibers. The invention also relates to a fabric containing thereof and to clothing comprising said fabric.

The present invention relates to a yarn comprising cut-resistant fibers and moisture-wicking fibers and to a fabric containing the same.

WO 2008/046476 discloses for example such a yarn containing cut-resistant filaments and/or cut resistant staple fibers. The cut resistant filaments or cut-resistant staple fibers can be made from polymeric materials e.g. polyethylene, aramids, or polybenzoxazole or can be made from glass, metal and other alike inorganic materials. Such yarns when used to manufacture fabrics provide the fabrics with excellent resistance against cutting.

It was observed that when yarns comprising only cut-resistant fibers are used to manufacture a fabric, the fabric manufactured thereof shows limited heat transfer and thermoregulating properties. It was also observed that said fabric responds less effectively to temperature changes in particular to rapid changes and when used in a garment, said fabric has poor sweat management. Especially in hot and humid environments, said fabrics get easily wet by perspiration and stick to the skin of a person wearing them and thus making that person feel uncomfortable.

To alleviate the above drawbacks, fabrics were manufactured from yarns comprising both cut-resistant fibers and moisture-wicking fibers. It was however observed that such fabrics still have a reduced heat transfer and unsatisfactory thermoregulating properties.

It is therefore an aim of the invention to offer a yarn, which provides a fabric manufactured thereof with resistance against cutting as well as with improved heat transfer properties. It is further aimed at offering a yarn that provides a fabric with improved thermoregulating properties, in particular said fabric having said properties when used at temperatures above room temperature, e.g. about 37° C.

The invention therefore provides a yarn comprising cut-resistant fibers and moisture-wicking fibers wherein said cut-resistant fibers and said moisture-wicking fibers are staple fibers.

It was found that unlike known yarns, the yarn of the invention, also referred to as the inventive yarn, provides a fabric manufactured thereof with improved heat transfer properties. It was also observed that fabrics manufactured from the inventive yarn show elevated thermoregulating properties when compared to known fabrics. A further particular advantage is that the inventive yarn can be easily and cheaply manufactured because it is based on commercially available starting materials.

It was observed that a fabric comprising the inventive yarn is particularly useful in manufacturing sports-related apparel, in particular apparel for sports which require strenuous activities under elevated temperature and/or humidity and where the probability of injuries by cutting, tear and/or abrasion are high, e.g. climbing, mountain biking, motor racing, and the like.

Therefore, the invention also relates to a fabric comprising the inventive yarn. An important advantage of the fabric of the invention, hereinafter also referred to as the inventive fabric, is that said fabric can be easily manufactured. Known fabrics can achieve a combination of cut resistance and heat transfer properties only with a complicated multilayered fabric construction. Such multilayered constructions are manufactured from yarns of moisture-wicking fibers and yarns of cut-resistant fibers separately used in the manufacturing process thereof. The inventive fabric however provides even in its most simplistic construction at least the same mentioned combination of cut resistant and heat transfer properties as the known multilayered fabrics. It was also observed that the inventive fabric has reduced shrinking and/or wrinkling. Furthermore, the inventive fabric has improved comfort.

A cut-resistant fabric having thermoregulating properties is known for example from WO 2005/002376. However, this fabric has a complicated multilayered construction and is furthermore designed for cold environments. It was observed that such a fabric has a limited heat conductivity and therefore not suitable for use in hot and/or humid environments.

By cut-resistant fibers is herein understood fibers which when assembled into a yarn provide a fabric manufactured from said yarn with higher resistance against cutting than when said fabric would have been manufactured from the same yarns, however said yarns consisting of cotton fibers, said cut resistance being determined using EN388 standard.

By heat transfer property of a fabric is herein understood a fabric that is capable to transport heat away from a warm body in contact thereof.

By thermoregulating property of a fabric is herein understood a fabric that is capable to keep the temperature of a body in contact thereto substantially constant, wherein said body continuously generates heat and has the tendency to increase its temperature over time.

A yarn for the purpose of the invention is an elongated body having a much larger length than its transversal dimensions and containing a plurality of fibers.

By fiber is herein understood an elongated body, the length dimension of which is much greater than its transverse dimensions of width and thickness. The fibers used according to the invention are staple fibers, i.e. fibers having discontinuous lengths. Staple fibers are usually obtained by cutting or stretch-breaking continuous filaments. For simplicity and unless stated otherwise, the staple fibres are referred to hereinafter as fibers.

The fibers preferably have a length between 20 mm and 300 mm, more preferably between 40 and 180 mm, most preferably between 50 and 150 mm. In a preferred embodiment, the fibers are obtained by stretch-breaking and have a length of between 60 and 130 mm. Preferably, the cut-resistant fibers have a length of between 50 and 300 mm, more preferably between 80 and 160 mm. Preferably, the moisture-wicking fibers have a length of between 20 and 150 mm, more preferably between 50 and 90 mm.

The titer of the fibers is preferably at least 0.1 dpf, more preferably at least 1.0 dpf, most preferably at least 2 dpf. The advantage thereof is that a fabric comprising lower dpf fibers has an improved comfort. Preferably said titer is at most 20 dpf, more preferably at most 10 dpf, most preferably at most 5 dpf.

Good results are obtained when the titer of the inventive yarn is at least 10 dtex, preferably at least 40 dtex, more preferably at least 70 dtex. The maximum titer of the inventive yarn is dictated only by practical reasons and is preferably at most 7500 dtex, more preferably at most 5000 dtex, most preferably at most 2500 dtex. A twist is preferably imparted to the yarn as it was observed that a twisted yarn has an improved mechanical stability. Preferably the twist coefficient is between 50 and 500.

The type of cut-resistant fibers used in the invention may vary widely and are preferably organic fibers.

Illustrative examples of organic cut-resistant fibers are for instance those manufactured from polymers including but not limited to for example polyamides and polyaramides, e.g. poly(p-phenylene terephthalamide) (e.g. Kevlar®), poly(metaphenylene isophthalamide) (e.g. Nomex®), poly(m-xylylene adipamide), poly(p-xylylene sebacamide), poly(2,2,2-trimethyl-hexamethylene terephthalamide), poly(piperazine sebacamide), and aliphatic and cycloaliphatic polyamides, e.g the copolyamide of 30% hexamethylene diammonium isophthalate and 70% hexamethylene diammonium adipate, the copolyamide of up to 30% bis-(-amidocyclohexyl)methylene, terephthalic acid and caprolactam; poly(tetrafluoroethylene) (PTFE); poly{2,6-diimidazo-[4,5b-4′,5′e]pyridinylene-1,4(2,5-dihydroxy)phenylene} (known as M5); poly(p-phenylene-2,6-benzobisoxazole) (PBO) (known as Zylon®); polyvinyl alcohols; and polyolefins e.g. homopolymers and copolymers of polyethylene and/or polypropylene.

Also combinations of the above-enumerated cut-resistant fibers may be used.

In a preferred embodiment, the cut-resistant fibers are polyaramid fibers, e.g. poly(p-phenylene terephthalamide) fibers (e.g. Kevlar®) or poly(metaphenylene isophthalamide) fibers (e.g. Nomex®). Also combinations thereof may be used. It is particularly preferred that such fibers be of substantially circular, flat or oblong cross-section, most preferably the former. Good results were obtained when polyaramid fibers were combined with polyolefin fibers, preferably polyethylene fibers.

In a more preferred embodiment, the cut-resistant fibers are fibers composed of polyethylene having preferably a substantially circular or flat or oblong cross-section, most preferably circular. Said fibers may be manufactured by any technique known in the art, preferably by melt or gel spinning. If a melt spinning process is used, the polyethylene starting material used for manufacturing thereof preferably has a weight-average molecular weight (Mw) between 60,000 and 600,000, more preferably between 60,000 and 300,000. An example of a melt spinning process is disclosed in EP 1,350,868 incorporated herein by reference. If the gel spinning process is used to manufacture said fibers, preferably an ultrahigh molecular weight polyethylene (UHMWPE) is used with an intrinsic viscosity (IV) of preferably at least 3 dl/g, more preferably at least 4 dl/g, most preferably at least 5 dl/g. Preferably the IV is at most 40 dl/g, more preferably at most 25 dl/g, more preferably at most 15 dl/g. Preferably the UHMWPE fibers are manufactured according to a gel spinning process as described in numerous publications, including EP 0205960 A, EP 0213208 A1, U.S. Pat. No. 4,413,110, GB 2042414 A, GB-A-2051667, EP 0200547 B1, EP 0472114 B1, WO 01/73173 A1, EP 1,699,954 and in “Advanced Fibre Spinning Technology”, Ed. T. Nakajima, Woodhead Publ. Ltd (1994), ISBN 185573 182 7. Known gel spun UHMWPE fibers are for example those commercialized by DSM N.V. the Netherlands under the name of Dyneema®.

Preferably, the cut-resistant fibers are organic fibers having a crystallinity of at least 50%, more preferably at least 75%, most preferably at least 90%. The crystallinity can be measured according to known methods in the art, e.g. by measuring the melting energy of the fibers with Dynamic Scanning calorimetry (DSC) and calculating the crystallinity therefrom. Most preferably, said organic fibers are high crystallinity polyethylene fibers manufactured as detailed hereinabove. It was observed that when in contact with a person's body, fabrics containing inventive yarns wherein the cut resistant fibers have increased crystallinity values show enhanced performance in keeping the body temperature at lower values for longer times. It was also observed that the person wearing said fabric begins to sweat later than when wearing known cut-resistant fabrics having the same construction.

A moisture-wicking fiber is herein understood a fiber, preferably a polymeric fiber, capable of transporting moisture along its length by capillary action. Polymers suitable for use in a process for manufacturing moisture-wicking fibers are those enumerated hereinabove in the section relating to cut resistant fibers and furthermore including polyesters, e.g. poly(ethylene terephthalate), poly(butylene terephthalate), and poly(1,4 cyclohexylidene dimethylene terephthalate); acrylic and nylon, e.g. poly(hexamethyleneadipamide) (known as nylon 6,6), poly(4-aminobutyric acid) (known as nylon 6). Further examples of suitable polymers can be found in U.S. Pat. No. 6,003,424 starting at column 5, line 23 and ending at column 8, line 15, the disclosure thereof being incorporated herein by reference. Fibers manufactured from said polymers are imparted moisture-wicking properties e.g. by coating them with hydrophilic agents or by producing said fibers with a non-round cross-section and with a plurality of channels along the longitudinal length of said fiber.

A first preferred embodiment of moisture-wicking fibers includes fibers, preferably polymeric fibers, which are treated with hydrophilic agents. Examples of such fibers and a method for manufacturing thereof is disclosed for instance in U.S. Pat. No. 7,012,033 B2 incorporated herein by reference. Examples of hydrophilic agents include ethoxylated polyesters, sulfonated polyesters, cellulose ethers, ethoxylated polyamides, copolymers of vinyl acetate and hydrophilic crosslinking agents. Further agents are disclosed in U.S. Pat. Nos. 4,137,181; 4,179,543; 4,294,883 and 4,707,407 incorporated herein by reference. Examples of commercially available hydrophilic agents include those sold under the tradenames of Eastman WD Size, Lubril QCX, also from Eastman Chemical, Methocel A-LV from Dow Chemical, and the like.

A second preferred embodiment of moisture-wicking fibers includes sculpted polymeric fibers having a non-round cross-section and a plurality of channels along their longitudinal length. Preferred examples of such fibers are polymeric fibers having a scalloped-oval cross-section. More preferred are fibers of polyester having a scalloped-oval cross-section as for example polyester fibers prepared according to U.S. Pat. No. 4,707,407 (column 4 and Example) incorporated herein by reference. Yet more preferred are polyester fibers preferably prepared according to U.S. Pat. No. 5,626,961 incorporated herein by reference, said fibers having an improved scalloped-oval cross-section with preferably at least 4 channels (also referred to as grooves or indentations), more preferably with at least 6 channels. Preferably these fibers are treated with hydrophilic agents to improve the fibers' moisture wicking properties. It was observed that an inventive fabric made of inventive yarns comprising the moisture-wicking fibers of this embodiment has enhanced performance in keeping the body temperature at lower values for longer times.

In a third preferred embodiment, the moisture-wicking fibers are polymeric fibers having a cross-sectional zig-zag shape, e.g. a double “W” shape, preferably with a 180 degree axis of symmetry. Examples of a manufacturing process as well as examples of suitable polymers for the manufacturing thereof are disclosed in U.S. Pat. No. 6,884,505 B2 incorporated herein by reference. Said polymers disclosed in U.S. Pat. No. 6,884,505 B2 starting at column 3, line 58 and ending on column 4, line 3 are also incorporated herein by reference. Preferably, the transverse cross-section of the fiber includes at least 3, more preferably at least 4, even more preferably at least 5, most preferably at least 7 contiguous segments in zig-zag configuration. It was observed that an inventive fabric made of inventive yarns comprising the moisture-wicking fibers of this embodiment also keeps the body temperature at lower values for longer times. Good results are obtained when adjacent segments form an angle between about 40 degrees and about 60 degrees. The cross-section of such a fiber can be defined in terms of a nominal width, a nominal length, a nominal channel depth or indentation and a nominal thickness. The ratio of the nominal width to the nominal thickness preferably is less than about 3, and the indentation to thickness ratio preferably is between about 0.25 and 0.6. Preferably, these fibers have a denier in the range of 0.1 to about 4.0 dpf.

It was observed that the inventive fabric presented a further improved heat transfer when said fabric comprised the inventive yarn wherein the yarn comprised an intimate blend of cut-resistant staple fibers and moisture wicking staple fibers. Hence, in a preferred embodiment, the inventive yarn comprises an intimate blend of cut-resistant fibers and moisture-wicking fibers, the fibers being randomly distributed across and/or along the yarn, preferably across and along said yarn. Methods for manufacturing such yarns are known in the art, e.g. via a ring-spinning process. It was furthermore observed that an inventive fabric comprising such a yarn shows good cut resistance and heat dissipation, i.e. the transported heat is dissipated with increased efficiency.

Good results were obtained when the ratio of cut-resistant fibers:moisture-wicking fibers in the inventive yarn is (0.3 to 3):1, preferably (0.4 to 2):1, more preferably (0.5 to 1):1. Preferably, said ratio is between 0.01:1 and 0.9:1, more preferably between 0.05:1 and 0.9:1, most preferably between 0.1:1 and 0.9:1.

In a further preferred embodiment, the inventive yarn comprises a sheath-core structure wherein the cut-resistant fibers form the core of the yarn and the moisture-wicking fibers are wrapped around the core to cover it at least 50%, more preferably at least 75%, most preferably completely. Method for manufacturing such yarns are known in the art. It was observed that an inventive fabric comprising such a yarn shows a further improved cut-resistance and enhanced heat dissipation. Also the moment when a person wearing said fabric begins sweating is further postponed.

Preferably, the inventive yarn also contains at least one elastomeric continuous filament, i.e. a filament having stretch and recovery. This can include for example the form of a sheath/core yarn having the elastomeric filament(s) as the core and the cut resistant and moisture-wicking fibers as the sheath, preferably a sheath wherein the cut-resistant and moisture-wicking fibers form an intimate blend, although it is not critical that the elastomeric filament(s) actually be fully covered by the sheath. It is also possible to use the elastomeric continuous filament separately when manufacturing a fabric containing said elastomeric filament and the yarn of the invention. In a specific embodiment, the yarn of the invention contains elastomeric staple fibers instead of elastomeric filaments, the advantage thereof being increased comfort. The preferred elastomeric filament or fiber is a filament or fiber manufactured from a long chain synthetic polymer composed of at least 85% by weight of a segmented polyurethane. Among the segmented polyurethanes of the spandex type are those described in, for example, U.S. Pat. Nos. 2,929,801; 2,929,802; 2,929,803; 2,929,804; 2,953,839; 2,957,852; 2,962,470; 2,999,839; and 3,009,901. The elastomeric filament in the inventive yarn is a continuous filament and can be present in the form of one or more individual filaments or one or more coalesced grouping of filaments. However, it is preferred to use only one coalesced grouping of filaments. Whether present as one or more individual filaments or one or more coalesced groupings of filaments the overall linear density of the elastomeric filament(s) in the relaxed state is preferably between 17 and 560 dtex with a preferred linear density range between 44 and 220 dtex. It was observed that a fabric containing such a yarn has increased heat transfer and thermoregulating properties and it responds with increased effectiveness to temperature changes in particular to rapid temperature changes.

Good results were obtained when the inventive yarn also contains heat-shrinking filaments or fibers, i.e. filaments or fibers which can shrink or curl upon a heat treatment. It was observed that an inventive yarn contain such heat-shrinking filaments or fibers achieves a good elasticity, i.e. it achieves stretch and recovery properties, after subjecting said yarn to a temperature of preferably between 60 and 140° C., more preferably between 80 and 120° C. In a preferred embodiment of filaments or fibers that may shrink or curl, a bi-component filament or fiber is used, for example a filament or fiber of bi-component nylon or bi-component polyester. Preferably, a filament or a fiber of a bi-component polyester is used. Such filaments and fibers are for example supplied by Invista. Such a filament or fiber comprises two filament or fiber elements, extending in the length direction of the filament or fiber being joined together at one face of each element. Preferably, one of the elements is of PET and the other element of a co-polyester. An alternative preferred heat-shrinking filament or fiber is a filament or fiber manufactured from polyacylonitrile (PAN). Further commercial heat-shrinking filaments known in the art include Dralon™ filaments delivered by Bayer, Germany.

In a first preferred embodiment of the inventive yarn, the cut-resistant fibers are polyaramid fibers and the moisture-wicking fibers are those of the second or third preferred embodiment of moisture-wicking fibers presented hereinabove. The advantage thereof is that an inventive fabric comprising the yarn of this embodiment shows improved cut-resistance and thermoregulating properties.

In a second preferred embodiment of the inventive yarn, the cut resistant fibers are polyethylene fibers and the moisture-wicking fibers are preferably those of the second, more preferably those of the third preferred embodiment of moisture-wicking fibers presented hereinabove. It was surprisingly found that a fabric manufactured thereof shows further enhanced thermoregulating properties, in that a person wearing a garment containing the inventive fabric shows a decreased amount of sweating or a postponed sweating. Furthermore, said fabric helps more efficiently in regulating the body temperature of a person wearing it. The fabric also shows an improved cut-resistance. These properties make such a fabric well suited for athletic wear and in particular for skate or skiwear because it protects the athlete from accidentally getting injured or being cut by the blade of a skate or by the sharp edge of a ski when falling or colliding with other skaters or skiers. An athletic wear containing said fabric also reduces athlete's sweating resulting from vigorous exercises of the athlete wearing it. A further advantage of such a fabric is that is simple to manufacture. Yet a further advantage is that such a fabric is more flexible and comfortable than known fabrics, e.g. the fabric disclosed in WO 2005/002376. Preferably, the polyethylene fibers in this second preferred embodiment of the inventive yarn are melt spun polyethylene fibers. An inventive fabric containing such a yarn shows improved cut-resistance, superior thermoregulating properties and also an improved softness and comfort. Alternatively, gel spun UHMWPE fibers can be used as polyethylene fibers in the second preferred embodiment of the inventive yarn. When an inventive fabric is manufactured thereof, said fabric has further improved lifetime and cut-resistance. It was also observed that such fabric has also an improved abrasion resistance and furthermore an improved tear resistance.

In a third preferred embodiment of the inventive yarn, said yarn further contain an inorganic filament, preferably a metal filament, more preferably a metal filament made from copper or steel. Preferably, said inorganic filament is wrapped around with an intimate blend of moisture-wicking fibers and cut-resistant fiber into a core/sheath yarn construction. The inorganic filament can be present in the form of one or more individual filaments or one or more coalesced grouping of filaments. However, it is preferred to use only one inorganic filament. It was observed that an inventive fabric manufactured from such yarn shows increased heat conductivity and also increased stiffness. Therefore, such a fabric is useful in constructing articles with increased mechanical stability, e.g. boots, shoes, gauntlets, hats and the like. Therefore, the invention relates also to such articles containing said fabric. Illustrative examples of useful inorganic filaments are ceramic filaments, metal filaments as for example stainless steel, copper, and aluminum metal alloys, but also glass filaments such as fibers formed from quartz, magnesia alumuninosilicate, non-alkaline aluminoborosilicate, soda borosilicate, soda silicate, soda lime-aluminosilicate, lead silicate, non-alkaline lead boroalumina, non-alkaline barium boroalumina, non-alkaline zinc boroalumina, non-alkaline iron aluminosilicate, cadmium borate, alumina filaments which include “saffil” fiber in eta, delta, and theta phase form, asbestos, boron, silicone carbide. Further examples include graphite and carbon filaments such as those derived from the carbonization of precursor filaments made of e.g. polyethylene, polyvinylalcohol, saran, aramid, polyamide, polybenzimidazole, polyoxadiazole, polyphenylene, PPR, petroleum and coal pitches (isotropic), mesophase pitch, cellulose and polyacrylonitrile.

The fabric of the invention may be of any construction known in the art, e.g. woven, knitted, plaited, braided or non-woven or combinations thereof. Woven fabrics may include plain weave, rib, matt weave and twill weave fabrics and the like. Knitted fabrics may be weft knitted, e.g. single- or double-jersey fabric or warp knitted. An example of a non-woven fabric is a felt fabric. Further examples of woven, knitted or non-woven fabrics as well as the manufacturing methods thereof are described in “Handbook of Technical Textiles”, ISBN 978-1-59124-651-0 at chapters 4, 5 and 6, the disclosure thereof being incorporated herein as reference. A description and examples of braided fabrics are described in the same Handbook at Chapter 11, more in particular in paragraph 11.4.1, the disclosure thereof being incorporated herein by reference.

Preferably the inventive fabric is a knitted or a woven fabric. Good results were obtained with circular or warp knit fabrics as well as with a tricot warp knit, flat knit or a plain weave fabric. It was observed that such fabrics show an increased degree of flexibility and softness while having an improved cut resistance and thermoregulating properties. A flat knit proved to be particularly advantageous when used to construct gloves.

The invention relates further to articles and in particular to clothing, e.g. outerwear, garments, raiment and the like comprising the inventive fabric. Examples of such articles include but are not limited to gloves, aprons, chaps, pants, shirts, jackets, coats, socks, undergarments, vests, hats and the like.

Particular apparels where the inventive fabric is advantageously used include sports related apparel, e.g. protective clothing for skaters, motorcyclists, cyclists, but also skiwear, head bands, and liners for helmets.

The invention also relates to the use of the inventive fabric in the above articles and in particular in the examples mentioned hereinabove.

### Test Methods

IV (for UHMWPE) is determined according to method PTC-179 (Hercules Inc. Rev. Apr. 29, 1982) at 135° C. in decalin, the dissolution time being 16 hours, with DBPC as anti-oxidant in an amount of 2 g/l solution, by extrapolating the viscosity as measured at different concentrations to zero concentration
Cut resistance of a fabric was determined in accordance with EN388.
Abrasion resistance and tear resistance of a fabric were measured in accordance with a modified EN388, wherein a sandpaper having a grid of 180 was used.
Thermal insulation of a dry fabric was measured with a Hohenstein Skin Model according to DIN EN 31 092 (February 1994), using a test climate having a temperature Tₐ of 20° C. and a humidity φₐ of 65% r.h. The reported values are the mean values of 3 or 6 single measurements on 3 different specimens of each fabric sample (lower values are better).
Thermal insulation of a wetted fabric in terms of drying time was measured with a Hohenstein Skin Model according to Standard-Test Specification BPI 1.3 (October 1985), using a test climate having a temperature Tₐ of 20° C. and a humidity φₐ of 65% r.h. The reported values are the mean values of 3 single measurements on 3 different specimens of each fabric sample (lower values are better).
Thermal insulation of a wetted fabric in terms of thermal resistance was measured with a Hohenstein Skin Model according to Standard-Test Specification BPI 1.3 (October 1985), using a test climate having a temperature Tₐ of 20° C. and a humidity φₐ of 65% r.h. The reported values are the mean values of 3 single measurements on 3 different specimens of each fabric sample (lower values are better).
Buffering capacity liquid sweat expressed in terms of a buffering index and of sweat transport for a fabric was measured with a Hohenstein Skin Model according to Standard-Test Specification BPI 1.2 (March 1994). For the buffering indes measurements a test climate was used having a temperature Tₐ of 35° C. and a humidity φₐ of 30% r.h. For the sweat transport measurements a test climate was used having a temperature Tₐ of 25° C. and a humidity φₐ of 50% r.h. The reported values are the mean values of 3 single measurements on 3 different specimens of each fabric sample (higher values are better).
Perceived surface temperature of a fabric was measured with a standard infrared apparatus.

### EXAMPLES AND COMPARATIVE EXPERIMENTS

### Example 1

A yarn was manufacture by a ring-spinning process, the yarn consisting of an intimate blend of ultra high molecular weight polyethylene fibers known as Dyneema® SK 75 from DSM Dyneema® and polyester fibers known as Dacron® type 702 fibers (Coolmax®) from Advansa Iberica S.L. (Spain). Dyneema® SK 75 fibers are known cut resistant fibers. Dacron® fibers are known moisture-wicking fibers having a W cross-section with a 180° symmetry, 4 contiguous segments in a zig-zag configuration, the adjacent segments forming an angle of 50°±15°. The ratio cut-resistant fibers/moisture-wicking fibers was 10/90. No yarn finish was used on the yarn.

The Dyneema® SK 75 fibers were obtained by stretch-breaking Dyneema® SK 75 filaments to an average length of from about 100 mm to about 150 mm. The titer of Dyneema® SK 75 fibers was 2.1 dpf. The crystallinity of Dyneema® SK 75 fibers is above 95%.

The Dacron® fibers were obtained by cutting Dacron® filaments and had an average length of about 76 mm. The titer of Dacron® fibers was 2.3 dpf.

A circular knitted, single jersey fabric was manufactured from the above yarn having an areal density (AD) (weight per square meter) of 219 gr/m².

### Example 2

Example 1 was repeated with the difference that the ratio cut-resistant fibers/moisture-wicking fibers in the yarn was 25/75.

### Example 3

Example 1 was repeated with the difference that the ratio cut-resistant fibers/moisture-wicking fibers in the yarn was 50/50.

### Example 4

Example 1 was repeated with the difference that the ratio cut-resistant fibers/moisture-wicking fibers in the yarn was 75/25.

### Comparative Experiment 1

Example 1 was repeated with the difference that the yarn consisted of cut-resistant fibers.

### Comparative Experiment 2

Example 1 was repeated with the difference that the yarn consisted of moisture-wicking fibers.

The properties of the fabrics of the above examples and comparative experiments are summarized in Table 1. It will be appreciated from the presented data that a fabric according to the invention has in addition to good cut resistance and abrasion resistance, less insulation in wet and dry circumstances, allowing for a good heat dissipation. Therefore, the time until which a person wearing a garment containing said fabric starts sweating is postponed in both hot and dry and wet and dry environments. Therefore, the inventive fabric can be advantageously used for heavy duty sportswear equipment, e.g. indoors ice skating or marathon running.

| | | | | | | | | | Thermal | | Buffering | |
|---|---|---|---|---|---|---|---|---|---|---|---|---|
| | | | | | | | | | insulation | Buffering | capacity | Thermal |
| | | | | | Tear strength | | | Thermal | wet fabric | capacity | liquid | insulation |
| | | | | | fabric | | Perceived | insulation | thermal | liquid | sweat- | wet fabric- |
| | Yarn | AD | | | (N) | | Surface | dry fabric | resistance | sweat- | sweat | drying |
| | tenacity | fabric | Cut | Abrasion | Length | Width | temp. | (×10³ | (×10³ | buffering | transport | time |
| Sample | (cN/tex) | (g/m²) | res. | res. | dir. | dir. | (° C.) | m²K/W) | m²K/W) | index | (g/m²h) | (min) |
| Ex 1 | 20.5 | 219 | 2 | 785 | 64.5 | 58.3 | 21.6 | 24.0 | −39 | 0.91 | 634 | 23.1 |
| Ex 2 | 37.6 | 219 | 2.1 | 1413 | 103.5 | 87.5 | 21.4 | 20.2 | −41.4 | 0.92 | 654 | 22.8 |
| Ex 3 | 80.8 | 217 | 3.05 | 1537 | 187 | 141.8 | 21.4 | 14.8 | −44.1 | 0.92 | 654 | 22.1 |
| Ex 4 | 115.7 | 206 | 4.03 | 4927 | 244.7 | 235.9 | 21.4 | 12.4 | −44.0 | 0.88 | 663 | 20.3 |
| Comp. | 150 | 211 | 4.4 | 5125 | 253.5 | 215.1 | 21.2 | 11.1 | −43.7 | 0.84 | 664 | 20.4 |
| Exp. 1 | | | | | | | | | | | | |
| Comp. | 19.4 | 215 | 1.36 | 175 | 56.7 | 48.7 | 21.8 | v26.0 | −36.0 | 0.90 | 626 | 24.9 |
| Exp. 2 | | | | | | | | | | | | |

1. A yarn comprising cut-resistant fibers and moisture-wicking fibers wherein said cut-resistant fibers and said moisture-wicking fibers are staple fibers.

2. The yarn of claim 1, wherein the yarn comprises an intimate blend of cut-resistant fibers and moisture-wicking fibers.

3. The yarn of claim 1 wherein the cut-resistant fiber is a polyethylene fiber.

4. The yarn of claim 1 wherein the moisture-wicking fiber is a sculpted polymeric fiber having a non-round cross-section and a plurality of channels along its longitudinal length.

5. The yarn of claim 1 wherein the moisture-wicking fiber is a polymeric fiber having a cross-sectional zig-zag shape.

6. The yarn of claim 1 wherein the cut resistant fibers have a crystallinity of at least 50% as measured by Dynamic Scanning calorimetry.

7. The yarn of claim 1 wherein the ratio of cut-resistant fibers:moisture-wicking fibers is between 0.01:1 and 0.9:1.

8. The yarn of claim 1 wherein the fibers have a length between 20 mm and 300 mm.

9. The yarn of claim 1 wherein the cut-resistant fibers have a length between 50 mm and 300 mm and the moisture-wicking fibers have a length between 20 mm and 150 mm.

10. The yarn of claim 1 further containing at least one elastomeric continuous filament.

11. The yarn of claim 1 further comprising heat-shrinking filaments or fibers.

12. A cut resistant fabric having thermoregulating properties comprising the yarn of claim 1.

13. The fabric of claim 12, said fabric being chosen from the group of fabrics consisting of woven, knitted, plaited and non-woven fabrics and combinations thereof.

14. Clothing comprising the fabric of claim 12.

15. The clothing of claim 14 wherein said clothing is chosen from the group consisting of gloves, aprons, chaps, pants, shirts, jackets, coats, socks, undergarments, vests and hats.
